(19) United States
(12) Patent Application Publication
(10) Pub. No.: US 2005/0133493 A1
(43) Pub. Date: Jun. 23, 2005

(54) Apparatus and method for heating micro-components mounted on a substrate

(76) Inventors: Peter E. Kirkpatrick, San Francisco, CA (US); Marc Finot, Palo Alto, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/739,242

(22) Filed: Dec. 18, 2003

(51) Int. Cl. H05B 3/06

(52) U.S. Cl. 219/542

(57) ABSTRACT

A package for heating a micro-component is disclosed. The package comprises a platform having a resistive heating element integral with the platform. The package further includes a micro-component disposed on the platform.

### FIELD OF THE INVENTION

The present invention relates generally to heating micro-components mounted on a substrate, and more specifically, to an apparatus and method for heating micro-components to minimize temperature fluctuations within the micro-components.

### BACKGROUND OF THE INVENTION

Micro-components comprise such components as: semiconductor devices, such as integrated circuits; optoelectronic components, such as laser diodes; and optical components, such as mini-lenses, which are typically mounted on a substrate, such as a circuit board. Operating performance for these micro-components can vary as a function of temperature, and these micro-components often require heat dissipation and/or cooling elements to maintain the micro-components within a desired operating temperature range. To provide a properly functioning micro-component, the operating temperature range must be known and controlled. While excessively high temperature conditions may cause performance problems of individual micro-components, operating temperatures that are too low can also adversely affect performance.

In addition to performance variations of a micro-component based on its temperature, the performance of a micro-component can also vary when the substrate temperature varies from a desired operating temperature. Variation in the substrate temperature from the desired operating temperature results in thermal expansion and contraction causing dimensional variations of the substrate. Moreover, these dimensional substrate variations cause a variation in the relative locations of the components mounted on the substrate. Consequently, control of the substrate temperature is desired.

A semiconductor laser diode (herinafter “laser diode”) converts electrical data signals into optical data signals. Several important laser diode operating parameters change as a function of temperature, resulting in poor performance if operated outside of its desired operating temperature range. Often, laser diodes operate in an environment that is too cold. These low temperatures cause performance problems and require additional heat to bring the laser diode to a desired temperature. Therefore, heating the laser diode is desired, and cooling is not necessary.

Thermoelectric (TE) devices are well known and used in the electronics industry to both heat and cool micro-components. However, for micro-components requiring only heating, such functionality is not necessary. For such applications, TE devices are costly and consume valuable real-estate on circuit boards. Furthermore, maintaining the micro-components within an appropriate operating temperature by cooling with TE devices generates waste heat energy resulting in a loss of efficiency.

### BRIEF DESCRIPTION OF THE DRAWINGS

FIG. 1 depicts a diagram illustrating several micro-components within an optical transmitter, in accordance with one embodiment of the present invention.

FIG. 2 depicts a block diagram of an apparatus in accordance with the invention.

### DETAILED DESCRIPTION OF THE INVENTION

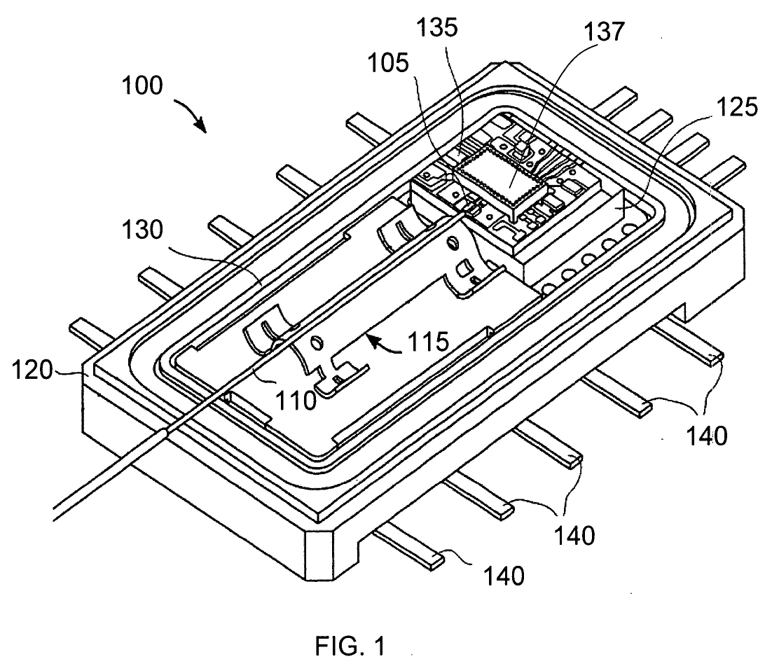

FIG. 1 shows an optoelectronic assembly package 100 adapted to convert electrical signals into optical signals. The package 100 contains a laser diode 105 to transmit optical signals along an optical fiber 110 supported by an optical fiber mount 15. Individual micro-components in the package 100 are mounted on a platform comprising a substrate 120 and a riser 125. Additionally, a cap (not shown) may be attached to a frame 130, thereby creating a protective seal. The laser diode 105 is mounted on the riser 125 to align the laser diode with the optical fiber 110. FIG. 1 illustrates several micro-components and electrically conductive patterns 135 also mounted on the riser 125 that are electrically connected to pins 140 mounted to the substrate 120, as is well known. As described below, a resistive heater is integral with the platform beneath the laser diode 105. The heater may be a printed Tantalum Nitride layer on the substrate 120 or riser 125, or embedded within either the substrate 120, or the riser 125. Additionally, a thermistor, as described below, is disposed in thermal proximity to the laser diode 105 to regulate the heater.

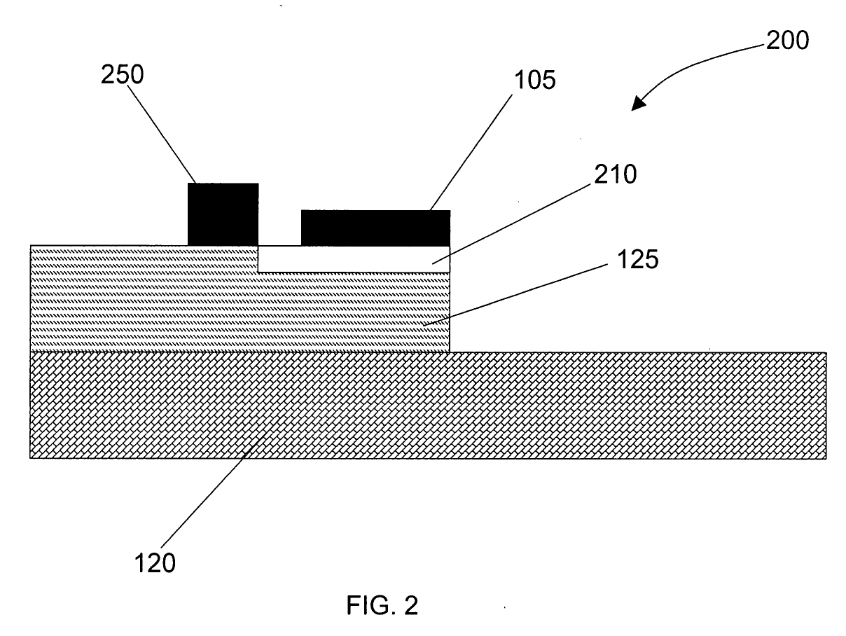

FIG. 2 shows a resistive heater 210 embedded in the riser 125, directly below the laser diode 105. Alternatively, the resistive heater 210 may be embedded in the substrate 120. A thermistor 250 is mounted in thermal proximity to the laser diode 105 to sense the temperature of the laser diode 105 and provide a temperature signal to regulate the heater 210. The thermistor 250 may also be embedded within the laser diode 105, or embedded within the substrate 120. Alternatively, thermocouples, IC sensors, and RTD elements may be used instead of the thermistor 250. Additionally, the temperature data provided by the thermistor 250 may be used with a controller to energize and de-energize the embedded resistive heater 210 when desired temperature thresholds are exceeded.

While the above description discussed a micro-component consisting of a laser diode, the invention is equally applicable to other components such as: semiconductor devices, such as integrated circuits; other optoelectronic components, such as light emitting diodes; and optical components, such as mini-lenses, which are typically mounted on a circuit board.

Although the foregoing text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the apparatuses described herein are illustrative only and are not limiting upon the scope of the invention.

1. A package for a laser diode, the package comprising:
a platform to support the laser diode; and
a resistive heating element integral with the platform and disposed between the laser diode and the platform.

2. The package of claim 1, wherein the heating element is embedded within the platform.

3. The package of claim 1, wherein the resistive heating element is printed on the platform.

4. The package of claim 3, wherein the resistive heating element is a Tantalum Nitride layer.

5. The package of claim 1, including a temperature sensor to provide a temperature signal to control the resistive heating element.

6. The package of claim 5, wherein the temperature sensor is disposed on the platform.

7. The package of claim 5, wherein the temperature sensor is embedded within the platform.

8. The package of claim 5, wherein the temperature sensor is a thermistor.

9. The package of claim 1, wherein the platform comprises a substrate and a riser, and the resistive heating element is integral with the riser.

10-15. (canceled)

16. The package of claim 10, including a temperature sensor disposed on the laser diode to provide a temperature signal to control the resistive heating element.

17. The package of claim 10, including a temperature sensor embedded within the laser diode to provide a temperature signal to control the resistive heating element.

18. A package for a laser diode, the package comprising:
a platform having a mounting location adapted for receiving the laser diode;
a resistive heater integral with the platform and disposed between the laser diode and the platform;
a temperature sensor mounted in thermal proximity to the mounting location, the sensor providing a signal indicative of the temperature of the laser diode; and
a controller responsive to the temperature signal for controlling the resistive heater.

19. The package of claim 18, wherein the platform consists of a substrate and a riser, and the resistive heater is embedded within the riser.

20. The package of claim 18, wherein the resistive heater is printed on the platform.

21. The package of claim 20, wherein the resistive heater is a Tantalum Nitride film.

22. A method of heating a laser diode disposed in a package comprising the steps of:
providing a platform adapted for receiving the laser diode; and
providing a resistive heater integral with the platform and disposed beneath the laser diode and between the laser diode and the platform.

23. The method of claim 22, wherein the resistive heater is embedded within the platform.

24. The method of claim 22, wherein the resistive neater is printed on the platform.

25. The method of claim 24, wherein the resistive heater is a Tantalum Nitride layer.

26. The method of claim 22, including a temperature sensor disposed on the platform to provide a temperature signal to control the resistive heater.

27. The method of claim 26, wherein the temperature sensor is a thermistor.

28. The method of claim 22, wherein the platform comprises a substrate and a riser, wherein the resistive heater is integrally disposed within the riser.

29. A method of heating a micro component laser diode disposed on a multi-layer platform comprising the steps of:
disposing a resistive heater beneath the laser diode on the multi-layer platform wherein the resistive heater is embedded within a layer of the multi-layer platform;
disposing a temperature sensor in thermal proximity to the laser diode disposed on the multi-layer platform to provide a signal indicative of the temperature of the laser diode; and
controlling the energy delivered to the resistive heater in response to the temperature signal received by the sensor.

30-31. (canceled)

32. A package for a laser diode, the package comprising:
a substrate having a riser adapted for receiving the laser diode;
a resistive heater integral with the riser and beneath the laser diode so the heater is disposed between the laser diode and the riser;
a thermistor mounted in thermal proximity to the laser diode, the thermistor providing a temperature signal indicative of the temperature of the laser diode; and
a controller responsive to the temperature signal for controlling the resistive heater.

33. The package of claim 32, wherein the resistive heater is embedded within the riser.

34. The package of claim 32, wherein the resistive heater is a Tantalum Nitride layer.

35. The package of claim 32, wherein the thermistor is embedded within the laser diode.

36. The package of claim 32, wherein the thermistor is embedded within the substrate.
